(19) United States
(12) Patent Application Publication
(10) Pub. No.: US 2014/0126448 A1
(43) Pub. Date: May 8, 2014

(54) ENERGY AWARENESS IN MOBILE COMMUNICATION USER EQUIPMENT AND NETWORKS, INCLUDING OPTIMIZATIONS BASED ON STATE COMPRESSION

(71) Applicants: Gottfried Punz, Dossenheim (DE); Stefan Schmid, Heidelberg (DE)

(72) Inventors: Gottfried Punz, Dossenheim (DE); Stefan Schmid, Heidelberg (DE)

(73) Assignee: NEC EUROPE LTD., Heidelberg (DE)

(21) Appl. No.: 14/128,738

(22) PCT Filed: Jun. 22, 2012
(86) PCT No.: PCT/EP2012/062074

§ 371 Date: Dec. 23, 2013

(30) Foreign Application Priority Data
Jun. 22, 2011 (EP) 11005077.0

(51) Int. Cl. H04W 52/02

(52) U.S. Cl. CPC H04W 52/0222
USPC 370/311

(57) ABSTRACT

A mobile communication system includes a core network having one or more elements that handle bearer processing and/or that store user equipment context information for at least one user equipment or device. Elements of the core network are configured to suspend some or all bearer processing and/or to compress portions of or the whole user equipment context information for the at least one user equipment or device. Elements of the core network may also be configured to transfer portions or all of the user equipment context information to other elements of the core network and/or to remove portions or all of the user equipment context information. Suspending some or all bearer processing and/or compressing portions of or the whole user equipment context information may be done for a user equipment or device in an energy saving state. Related methods and a user equipment device are also described.

### FIELD OF THE INVENTION

Embodiments of the invention relate to energy awareness and savings in mobile communications user equipment and networks.

### BACKGROUND

Energy saving is becoming increasingly important for the design and deployment of mobile networks, such as the newest generation of 3^{rd} Generation Partnership Project (3GPP) technology, i.e. Evolved Packet System (EPS) and beyond. Energy savings in the radio access currently has the highest priority, but it is also clear that energy savings in the core network (with main entities such as a mobility management entity (MME), serving gateway (SGW), and packet data network (PDN) gateway (PGW)) has to be considered next. The possible gain in terms of saved energy is currently difficult to predict, but these entities are comparable to high-end servers in data centers, for which similar energy savings efforts are undertaken. Further, it should be recognized that any energy savings gained in the server hardware itself automatically delivers a corresponding energy savings for its cooling, and can also be leveraged to reduce the size of any backup power supply system (or to prolong the backup time with a given size of such a system).

However, current energy savings approaches and efforts limit themselves by not actively involving the user and user equipment (UE). In particular, traditional approaches hide energy savings functionality from the user and the UE. Without involving the user and UE, energy savings-related optimizations are more difficult and less efficient than they could be.

### SUMMARY

Embodiments of the invention provide an additional explicit energy saving state (in addition to the existing idle mode state) for user equipment (UE) devices, which is exchanged between the UE and the network. This enables the network to minimize the processing and context state for that UE, for example by suspending bearer processing among mobile core network elements. It should be noted that, as a simplification of the more general embodiment, this UE state may also be represented only in the network. Further, this enables the network to compress UE context/bearer state in core network nodes, which allows the nodes to handle more UEs with the same memory and/or to save energy by hibernating parts of the memory. Embodiments of the invention may also enable the network to offload the compressed context/bearer state to another core network entity, allowing hibernation/shutdown of network devices/nodes for the purpose of energy saving. Another embodiment may utilize the same principles on the network side but avoid the awareness of such energy saving state in the UE.

In some embodiments, a mobile communication system is described. The mobile communication system includes a core network including one or more elements that handle bearer processing and/or that store user equipment context information for at least one user equipment or device that communicates through the core network. The elements of the core network are configured to suspend some or all bearer processing and/or to compress portions of or the whole user equipment context information for the at least one user equipment or device.

In some embodiments, the elements of the core network are configured to transfer portions or all of the user equipment context information to other elements of the core network and/or to remove portions or all of the user equipment context information.

In some embodiments, the elements of the core network are configured to suspend some or all bearer processing and/or to compress portions of or the whole user equipment context information for a user equipment or device in an energy saving state. In some such embodiments, the communication system includes a user equipment. The user equipment is configured to operate in one of several states, including an explicit energy saving state. The user equipment is further configured to inform the core network when the user equipment enters the explicit energy saving state. In some embodiments, the user equipment is further configured to inform the core network when the user equipment exits the explicit energy saving state.

In some embodiments, elements of the core network are configured to suspend some or all bearer processing and/or to compress portions of or the whole user equipment context information for the user equipment when the user equipment enters the explicit energy saving state. In some embodiments, elements of the core network are configured to transfer portions or all of the user equipment context information to other elements of the core network and/or to remove portions or all of the user equipment context information when the user equipment enters the explicit energy saving state.

In some embodiments, the mobile communication system is configured to create a unique identifier for the user equipment context information. This provides for fast re-establishment of the user equipment context information in the core network when the user equipment exits the explicit energy saving state. In some such embodiments, the user equipment context information can be re-established on a different entity of the core network when the user equipment exits the explicit energy saving state.

In some embodiments, the mobile communication system comprises a 3GPP system. In some embodiments, the core network includes a mobility management entity, and a dedicated control plane interface is provided at the mobility management entity to trigger a user equipment state change from the explicit energy saving state to an idle state or an active state.

In some embodiments, the elements of the core network include a mobility management entity (i.e. MME or SGSN), a serving gateway (i.e. S-GW or SGSN), and a packet data network gateway (i.e. PDN-GW or GGSN). The packet data network gateway maintains compressed packet data network context information for user equipment in the explicit energy saving state for re-establishment of the packet data network connection in the serving gateway and/or mobility management entity upon terminating traffic towards the user equipment.

In some 3GPP embodiments, the user equipment sends a tracking or routing area update request with an indication that it is entering the explicit energy saving state to its current mobility management entity in the core network when the user equipment enters the explicit energy saving state. In some embodiments, the user equipment sends a tracking or routing area update request to a mobility management entity in the core network when the user equipment exits the explicit energy saving state. In some of these embodiments, the tracking area update request includes a serving gateway ID or a packet data network gateway ID as context pointers.

In some embodiments, the elements of the core network store the compressed user equipment context information in non-volatile memory.

Further embodiments provide a method for saving energy in a mobile communication system. The method includes suspending some or all bearer processing on a core network element and/or compressing portions of or the whole user equipment context information on the core network element for at least one user equipment or device that communicates through the core network. In some embodiments, the method further includes transferring portions or all of the user equipment context information to other elements of the core network and/or removing portions or all of the user equipment context information.

In some embodiments, the method further includes providing an explicit energy saving state on a user equipment, and informing the core network when the user equipment enters the explicit energy saving state. In some embodiments, the method further includes informing the core network when the user equipment exits the energy saving state.

In some embodiments, the method further includes suspending some or all bearer processing on a core network element and/or compressing portions of or the whole user equipment context information on the core network element when the user equipment enters the explicit energy saving state. In some embodiments, the method further includes transferring portions or all of the user equipment context information to other elements of the core network and/or removing portions or all of the user equipment context information when the user equipment enters the explicit energy saving state.

In some embodiments, the method further includes creating a unique identifier for the user equipment context information. This provides for fast re-establishment of the user equipment context information in the core network when the user equipment exits the explicit energy saving state.

Further embodiments provide a user equipment device for use in a mobile communication system including a core network. The user equipment device is configured to operate in one of several states, including an explicit energy saving state. The user equipment device is further configured to inform the core network when the user equipment device enters the explicit energy saving state.

In some embodiments, the user equipment device is a 3GPP device. Such a user equipment device may be configured to send a tracking area update request with an indication that it is entering the explicit energy saving state to a current mobility management entity in the core network when the user equipment device enters the explicit energy saving state.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a simplified version of the current distribution of user equipment (UE) context data in evolved packet system (EPS) for the general packet radio system (GPRS) tunneling protocol (GTP) based architecture;

FIG. 2 shows a UE state model with an explicit energy saving state, in accordance with an embodiment of the invention;

FIGS. 3A-3C show three embodiments of removal, compression and transfer of the context data for a UE in a mobile communications network, in accordance with embodiments of the invention;

FIGS. 4A-4B show information flows for entering and leaving the energy saving state from the UE side (FIG. 4A) and for terminating traffic (FIG. 4B) in accordance with an embodiment of the invention;

FIGS. 5A-5B show information flows for entering and leaving the energy saving state from the UE side (FIG. 5A) and for terminating traffic (FIG. 5B) in accordance with another embodiment of the invention; and

FIGS. 6A-6B show information flows for entering and leaving the energy saving state from the UE side (FIG. 6A) and for terminating traffic (FIG. 6B) in accordance with a further embodiment of the invention.

### DESCRIPTION

The description is written in terms of 3GPP evolved packet system (EPS), since this represents a well-known and widely used set of standards that would be understood by those of ordinary skill in the art, and in which enhancements and optimizations may be realized with effect in the current market. An understanding of the standards and systems that make up the 3GPP evolved packet system is assumed in the description below. Further information on 3GPP is available, for example, in the 3GPP specifications, which can be found at www.3gpp.org/specifications. While the description is provided in terms of 3GPP EPS, it will be understood that the basic ideas discussed below could be applied to 2G and 3G mobile packet switched (PS) network technologies (e.g., by substituting the mobility management entity (MME) with a servicing GPRS support node (SGSN) and the PDN gateway (PGW) with a gateway GPRS support node (GGSN), with corresponding changes in procedures), and other mobile network technologies in a similar fashion.

As noted above, current energy savings approaches and efforts fail to actively involve the user and user equipment, making optimizations more difficult and less efficient than they could be. To illustrate this, two proposed energy savings schemes in/for mobility management entities (MMEs—i.e. the main control plane node in the evolved packet core (EPC)) during off-peak hours are discussed. Under a first scheme, periodic tracking area update (TAU) signaling is used for offloading all contexts of UEs in idle mode from an MME targeted for switch-off (e.g., to save energy during off-peak hours) to an alternative MME. For UEs in active mode, an artificial or “dummy” S1-based handover (where the UE actually remains within the same cell) is generated, which similarly allows changing the MME within the corresponding signaling flow. This handover has no impact or relationship with the radio access—it is just using similar procedures in the core network as those that would be used for a genuine handover. The latency of the solution of this proposal is roughly on the order of the maximum (or average, if all UEs are assigned the same) periodic TAU timer, i.e. by default approximately one hour. Such a mechanism for active mode UEs is described in detail in PCT application PCT/JP2011/067560, published as WO/2012/023415, and directed to “SLEEPING EPC FOR ENERGY SAVING IN LTE”.

Another, further improved scheme might attempt to speed up the process by virtue of a bulk context transfers with a handshake between MMEs and SGWs. With this method, it is estimated that the complete offload of an MME could be achieved within approximately one or two minutes. A more detailed description of this mechanism is provided in co-pending PCT application PCT/EP2012/056362, directed to a “Method and A System for Distributing of User Equipment Context in an Evolved Packet System.”

With both of these schemes, the traditional concept of UE's context handling, as well as related signaling, is either unchanged or (as far as possible) optimized, but no fundamental change of the concept is envisaged. Also, the existing idle mode state for a UE does not yet allow for enough reduction in signaling and in the amount of UE context in the network, as would be desirable for optimal energy savings strategies.

With increasing pressure from both authorities and the market, the manner in which energy savings are managed should be reconsidered. Embodiments of the invention leverage gains from explicit awareness with respect to energy saving in the UEs and the mobile network. It is expected that in the future, end users and applications may also be willing to collaborate on energy efficiency.

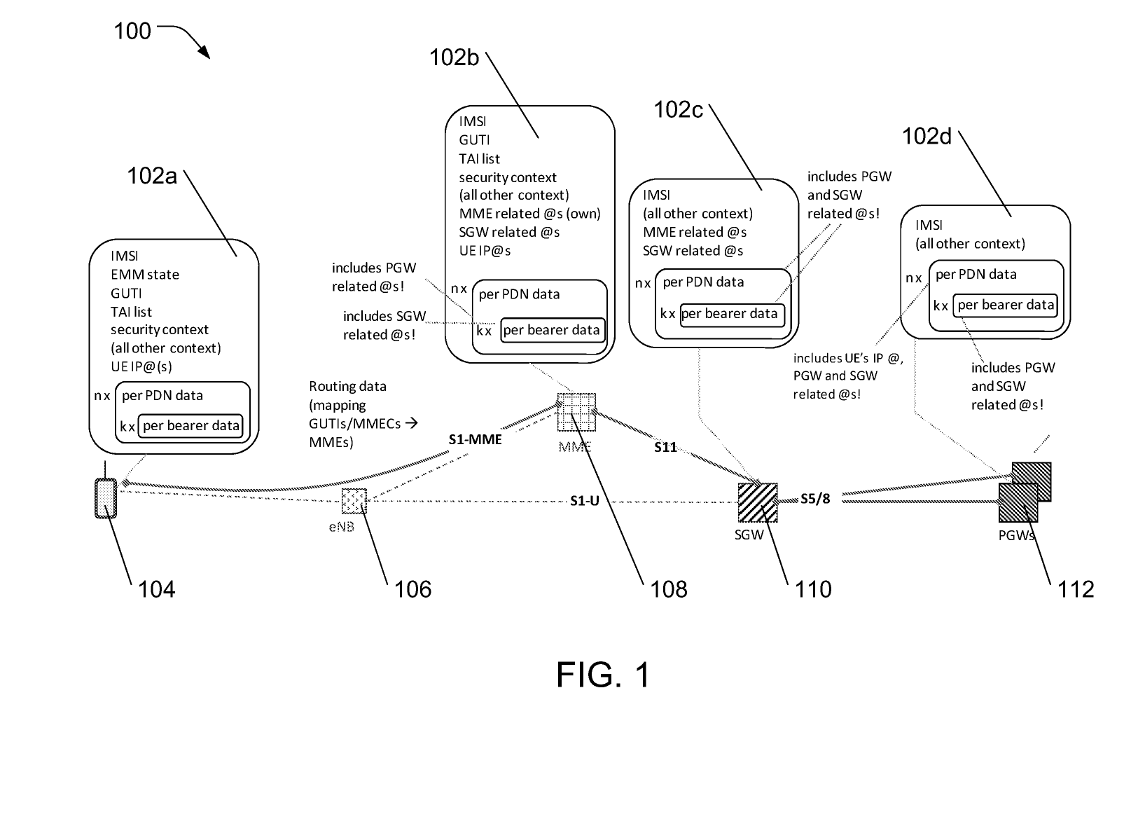

For reference, FIG. 1 shows a simplified version of the current distribution of UE context data in EPS for the general packet radio system (GPRS) tunneling protocol (GTP) based architecture. It should be noted that, although there are some differences with the proxy mobile IP (PMIP) based architecture variant, this is not essential with respect to the invention. Additionally the routing table on evolved node B (eNB), which is used to find the proper MME (i.e. the UE context storage) from a UE's temporary ID (global unique temporary identifier (GUTI)), is shown. A large portion of a UE's context data describes the packet data network (PDN) connection(s) and bearer(s). The detailed context data is defined in 3GPP specification TS 23.401, “General Packet Radio Service (GPRS) enhancements for Evolved Universal Terrestrial Radio Access Network (E-UTRAN) access”, sub-clause 5.7. In FIG. 1, the distribution 100 includes context data 102a-d, distributed as shown across UE 104, eNB 106, MME 108, serving gateway (SGW) 110, and PDN gateways (PGWs) 112.

For reference, the tables below provide an overview of the items related to MME, SGW and PGW identifiers/‘addresses’ (abbreviated as ‘@ s’ in FIG. 1). Tables 1a, 1b, and 1c are extracted from Table 5.7.2-1: MME MM and EPS bearer Contexts of the specification (3GPP TS 23.401):

TABLE 1a
MME MM and EPS bearer contexts (part 1)

| | |
|---|---|
| MME IP address for S11 | MME IP address for the S11 interface (used by |
| | S-GW) |
| MME TEID for S11 | MME Tunnel Endpoint Identifier for S11 |
| | interface. |
| S-GW IP address for | S-GW IP address for the S11 and S4 interfaces |
| S11/S4 | |
| S-GW TEID for S11/S4 | S-GW Tunnel Endpoint Identifier for the S11 |
| | and S4 interfaces. |
| MME UE S1AP ID | Unique identity of the UE within MME. |

TABLE 1b
MME MM and EPS bearer contexts (part 2)
For each active PDN connection:

| | |
|---|---|
| PDN GW Address in Use | The IP address of the PDN GW |
| (control plane) | currently used for sending control |
| | plane signalling. |
| PDN GW TEID for S5/S8 | PDN GW Tunnel Endpoint Identifier |
| (control plane) | for the S5/S8 interface for the control |
| | plane. (For GTP-based S5/S8 only). |
| PDN GW GRE Key for uplink | PDN GW assigned GRE Key for the |
| traffic (user plane) | S5/S8 interface for the user plane for |
| | uplink traffic. (For PMIP-based S5/S8 |
| | only) |

TABLE 1c
MME MM and EPS bearer contexts (part 3)
For each bearer within the PDN connection:

| | |
|---|---|
| IP address for S1-u | IP address of the S-GW for the S1-u interfaces. |
| TEID for S1u | Tunnel Endpoint Identifier of the S-GW for the S1-u |
| | interface. |

Tables 2a, 2b and 2c are extracted from Table 5.7.3-1: S-GW EPS bearer context of the specification (3GPP TS 23.401):

TABLE 2a
S-GW EPS Bearer Context (part 1)

| | |
|---|---|
| MME TEID for S11 | MME Tunnel Endpoint Identifier for |
| | the S11 interface |
| MME IP address for S11 | MME IP address for the S11 interface. |
| S-GW TEID for S11/S4 | S-GW Tunnel Endpoint Identifier for |
| (control plane) | the S11 Interface and the S4 Interface |
| | (control plane). |

TABLE 2b
S-GW EPS Bearer Context (part 2)
For each active PDN connection:

| | |
|---|---|
| P-GW Address in Use | The IP address of the P-GW currently |
| (control plane) | used for sending control plane |
| | signalling. |
| P-GW TEID for S5/S8 | P-GW Tunnel Endpoint Identifier for |
| (control plane) | the S5/S8 interface for the control |
| | plane. (For GTP-based S5/S8 only). |
| P-GW Address in Use | The IP address of the P-GW currently |
| (user plane) | used for sending user plane traffic. (For |
| | PMIP-based S5/S8 only) |
| P-GW GRE Key for uplink | PDN GW assigned GRE Key for the |
| traffic (user plane) | S5/S8 interface for the user plane for |
| | uplink traffic. (For PMIP-based S5/S8 |
| | only) |
| S-GW IP address for S5/S8 | S-GW IP address for the S5/S8 for the |
| (control plane) | control plane signalling. |
| S-GW TEID for S5/S8 | S-GW Tunnel Endpoint Identifier for |
| (control plane) | the S5/S8 control plane interface. (For |
| | GTP-based S5/S8 only). |
| S-GW Address in Use | The IP address of the S-GW currently |
| (user plane) | used for sending user plane traffic. (For |
| | PMIP-based S5/S8 only) |
| S-GW GRE Key for downlink | Serving GW assigned GRE Key for the |
| traffic (user plane) | S5/S8 interface for the user plane for |
| | downlink traffic. (For PMIP-based |
| | S5/S8 only) |

TABLE 2c
S-GW EPS Bearer Context (part 3)
For each EPS Bearer within the PDN Connection:

| | |
|---|---|
| P-GW Address in Use | The IP address of the P-GW currently used |
| (user plane) | for sending user plane traffic. (For GTP- |
| | based S5/S8 only). |
| P-GW TEID for S5/S8 | P-GW Tunnel Endpoint Identifier for the |
| (user plane) | S5/S8 interface for the user plane. (For |
| | GTP-based S5/S8 only). |
| S-GW IP address for S5/S8 | S-GW IP address for user plane data |
| (user plane) | received from PDN GW. (For GTP-based |
| | S5/S8 only). |
| S-GW TEID for S5/S8 | S-GW Tunnel Endpoint Identifier for the |
| (user plane) | S5/S8 interface for the user plane. (For |
| | GTP-based S5/S8 only). |

Tables 3a and 3b are extracted from Table 5.7.4-1: P-GW context of the specification (3GPP TS 23.401):

TABLE 3a
P-GW Context (part 1)
For each APN in use:
For each PDN Connection within the APN:

| | |
|---|---|
| S-GW Address in Use | The IP address of the S-GW currently |
| (control plane) | used for sending control plane |
| | signalling. |
| S-GW TEID for S5/S8 | S-GW Tunnel Endpoint Identifier for |
| (control plane) | the S5/S8 interface for the control |
| | plane. (For GTP-based S5/S8 only). |
| S-GW Address in Use | The IP address of the S-GW currently |
| (user plane) | used for sending user plane traffic. (For |
| | PMIP-based S5/S8 only). |
| S-GW GRE Key for downlink | Serving GW assigned GRE Key for the |
| traffic (user plane) | S5/S8 interface for the user plane for |
| | downlink traffic. (For PMIP-based |
| | S5/S8 only). |
| P-GW IP address for S5/S8 | P-GW IP address for the S5/S8 for the |
| (control plane) | control plane signalling. |
| P-GW TEID for S5/S8 | P-GW Tunnel Endpoint Identifier for |
| (control plane) | the S5/S8 control plane interface. (For |
| | GTP-based S5/S8 only). |
| P-GW Address in Use | The IP address of the P-GW currently |
| (user plane) | used for sending user plane traffic. (For |
| | PMIP-based S5/S8 only). |
| P-GW GRE Key for uplink | PDN GW assigned GRE Key for the |
| traffic (user plane) | S5/S8 interface for the user plane for |
| | uplink traffic. (For PMIP-based S5/S8 |
| | only). |

TABLE 3b
P-GW Context (part 2)
For each EPS Bearer within the PDN Connection:

| | |
|---|---|
| S-GW Address in Use (user plane) | The IP address of the S-GW currently |
| | used for sending user plane traffic. |
| S-GW TEID for S5/S8 (user plane) | S-GW Tunnel Endpoint Identifier for |
| | the S5/S8 interface for the user plane. |
| P-GW IP address for S5/S8 | P-GW IP address for user plane data |
| (user plane) | received from PDN GW. |
| P-GW TEID for S5/S8 (user plane) | P-GW Tunnel Endpoint Identifier for |
| | the GTP Based S5/S8 interface for |
| | user plane. |

Table 4 lists commonly used acronyms and abbreviations, for convenience:

TABLE 4
Acronyms and Abbreviations

| | |
|---|---|
| DB | Database |
| eNB | Evolved Node B |
| EPC | Evolved Packet Core |
| EPS | Evolved Packet System |
| ES | Energy Saving |
| GUTI | Global Unique Temporary Identifier |
| GTP | GPRS Tunneling Protocol |
| GW | Gateway |
| IMSI | International Mobile Subscriber Identity |
| MME | Mobility Management Entity |
| MMEC | MME Code |
| NW | Network |
| PDN | Packet Data Network |
| PGW | PDN Gateway |
| PMIP | Proxy Mobile IP |
| RAN | Radio Access Network |
| SGW | Serving Gateway |
| TAI | Tracking Area Index |
| TAU | Tracking Area Update |
| TEID | Tunnel Endpoint Identifier |
| UE | User Equipment |

It should be noted that some UE context data in a node may refer to IDs managed by the node itself (e.g. own IP address and TEID). In a simplified notation, as used in FIG. 1 and other figures, “n” indicates the number of PDN connections and “k” the number of bearers (within one considered PDN connection; the fact that “k” may differ per PDN connection and should appear with index running from 1 to “n” is ignored here). “x” denotes multiplication.

In the following description dealing with energy savings states in UEs, only UEs in idle mode are considered, since a UE in active mode is inherently not in energy saving state. Information flows are based on the GTP protocol. The mapping onto PMIP can be done according to well-known methods for handling differences between these two protocol types. It will be further understood that although the embodiments are described for non-roaming UEs, the concepts illustrated in the embodiments of the invention are also applicable in roaming. The methods described here are generally compatible with “offloading” UE context data from a source MME to alternative (target) MMEs, for the purpose of energy saving (by switch-off of the source MME), as mentioned above under paragraphs [0025] and [0026].

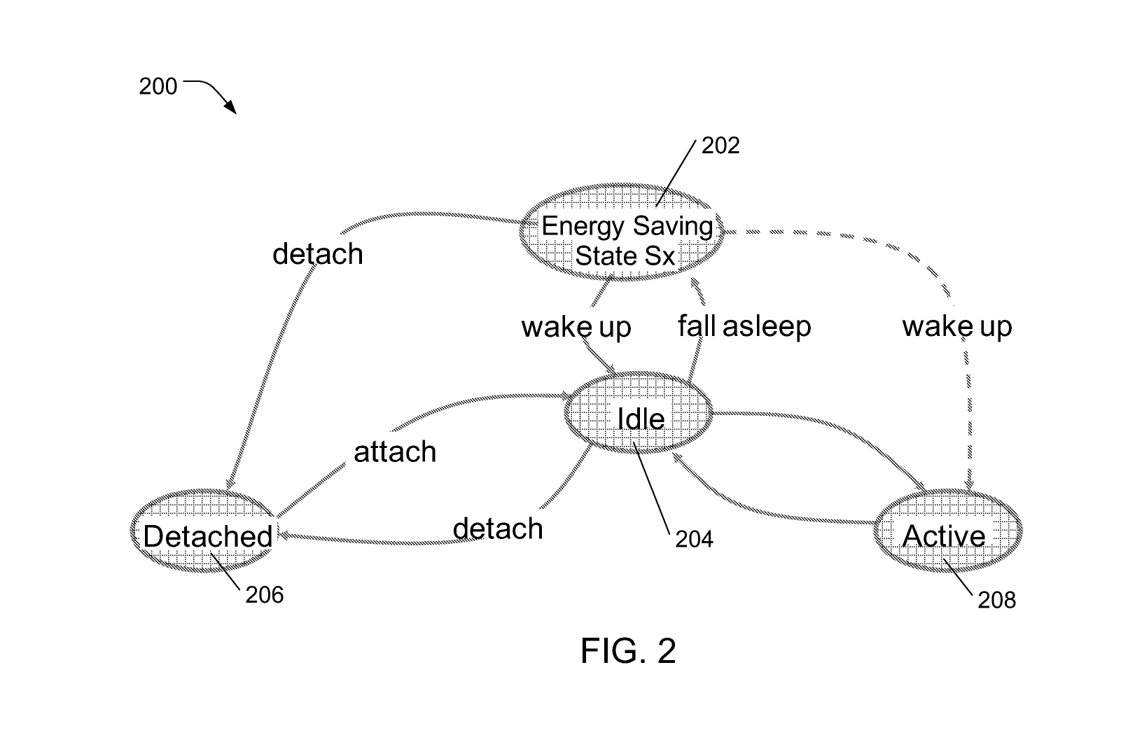

In accordance with various embodiments of the invention, clear and explicit definitions of energy saving states are provided for a 3GPP UE. FIG. 2 shows a UE state model that has been modified from the existing one in 3GPP in this way. In state model 200, an energy saving (ES) state Sx 202 is added to the conventional UE state model, between an idle state 204 and a detached state 206. An active state 208 is also present in the state model 200. It will be understood that in a more general scheme, more than one such energy saving state may be added. For the rest of this description, the number of ES states is assumed to be one, but it will be understood that there may be multiple such ES states. The notions of “falling asleep” (entering the ES state) and “waking up” (leaving the ES state) are introduced to describe state transitions into/out of an ES state. “Wake-up” generally means that the UE transits from an ES state 202 into the idle state 204. As will be understood, a “wake-up” state transition from an ES state 202 directly into the active state 208 may also be realized, or may be left out of the model. The details the procedure for the UE initiated service request may depend on whether such a transition is possible.

Generally, when in one of the ES states, the UE exhibits lower activity and has reduced expectations on latency for its subsequent activities. However, even in an ES state, all principal functionality should be guaranteed. For example, the UE's idle mode procedures are performed, in particular cell and public land mobile network (PLMN) (re)selection, however, it is expected that tracking area updates (TAUs) would result only infrequently. Also, it is expected that the UE would remain reachable for terminating traffic, but with higher latency.

The benefit from explicitly modelling these new UE state(s) is that the network can take advantage of the defined ES state(s) and, e.g., withdraw its prepared-ness for immediate response to UE actions. This allows both the reduction of processing (bearer/PDN connection maintenance) and state information (UE related context information—e.g. through “state compression”) in the network. This may be especially advantageous for devices with infrequent communication (e.g. machine-to-machine (M2M) devices).

Context data in the 3GPP network “above” the SGi reference point (e.g. IP Multimedia Subsystem (IMS), application servers, value added service platforms) is not considered in detail here, but can be utilized in accordance with embodiments of the invention. For example, for the purpose of continued reachability via IMS, the UE may send a session initiation protocol (SIP) update message to the IMS before entering the ES state (e.g. a Re-Register message), to indicate that it will change to ES state, so that the IMS can prolong the registration timer sufficiently, e.g. to 8 hours and no timeout/deregistration occurs. Since the IMS can be made known that a UE is in an ES state, it may also adapt its signalling-related timer in order to cope with the potentially increased latency of reaching the UE initially. Other examples how to use the ES state in the network are, for example, as fine tuned supplementary services (i.e. for call redirection), and/or as a new, “green” presence state.

In ES state Sx 202, the added latency is estimated to be considerably less than (e.g. 50% of) the latency for an initial attach.

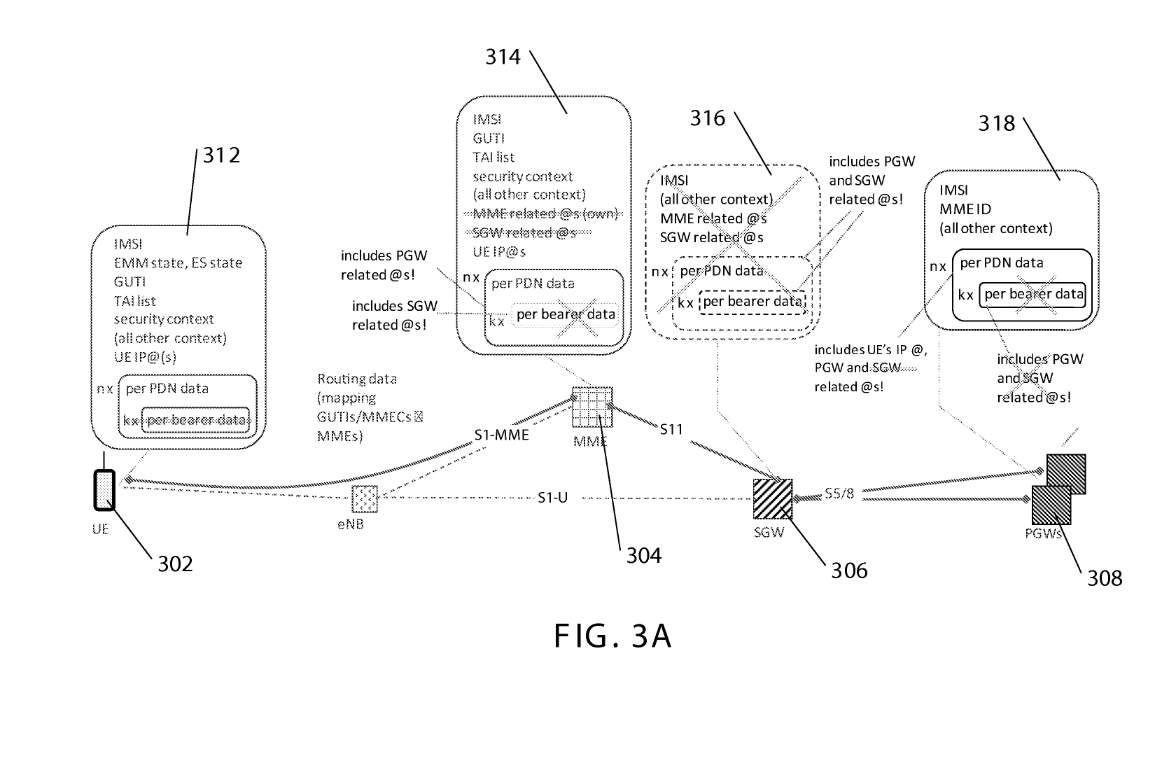

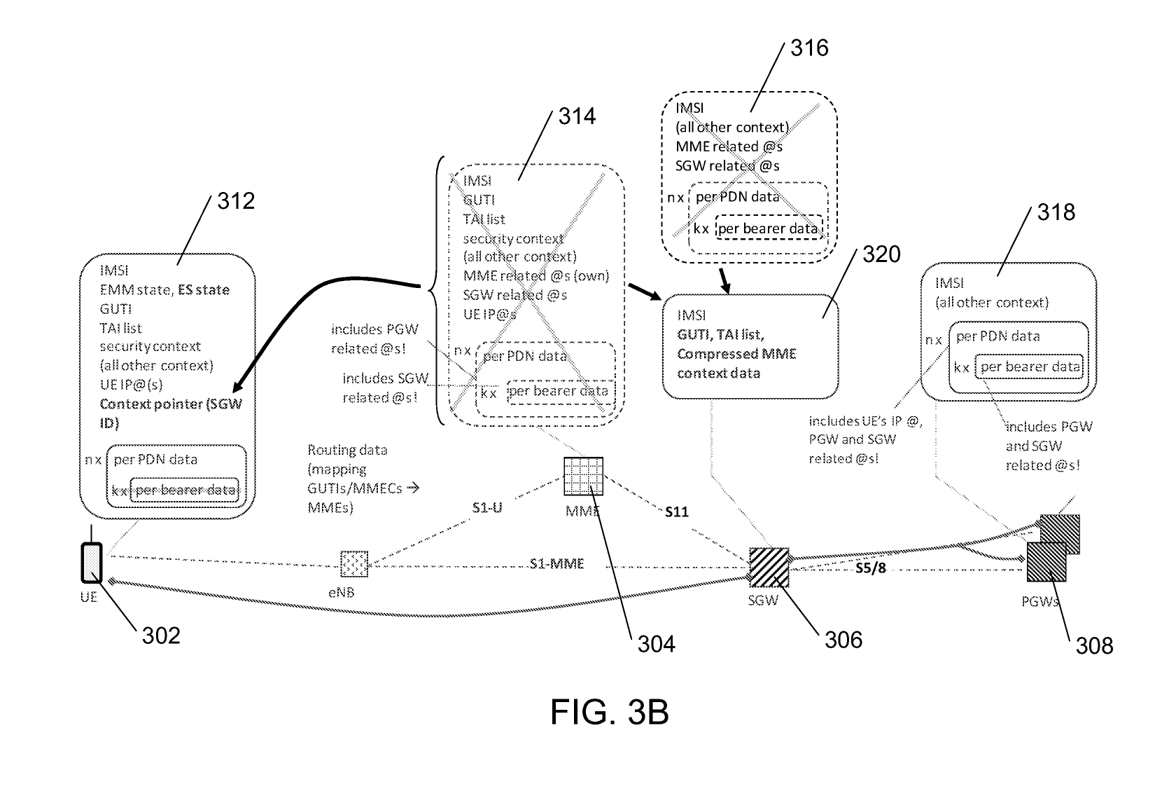

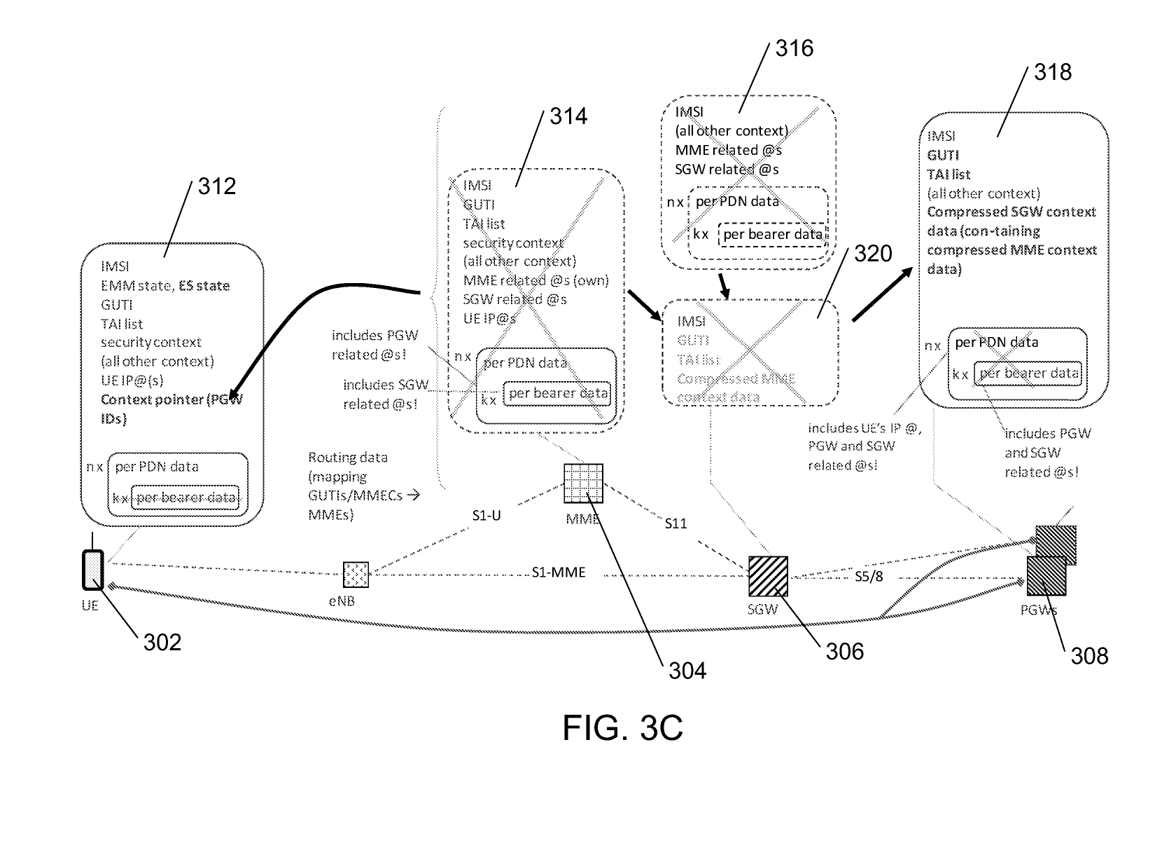

Because the ES states are explicit, among other benefits, the network can compress state information for an established bearer/PDN connection for a UE, reducing the UE's context data in the network. A first embodiment of such compression is shown in FIG. 3a, with possibly removed or compressed context data indicated as crossed out, e.g. SGW context data 316 at the serving gateway (SGW) 306. FIG. 3a additionally shows the context information still kept for a UE in various network entities, including the UE 302, with UE context data 312, the mobility management entity (MME) 304, with MME context data 314 and the PDN gateways (PGWs) 308, with PGW context data 318.

Thus, as seen in FIG. 3a, bearer-related context information can be removed, while a limited amount of context information in the MME and PGW(s) is retained.

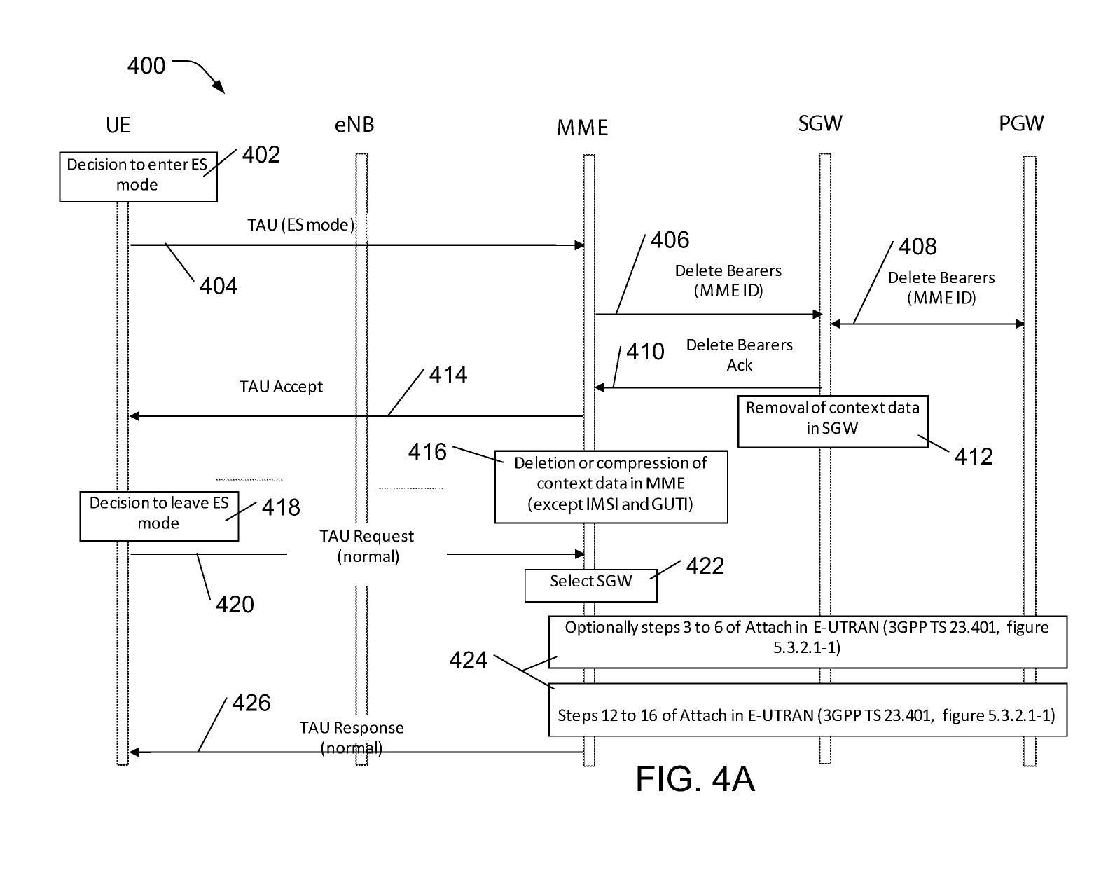

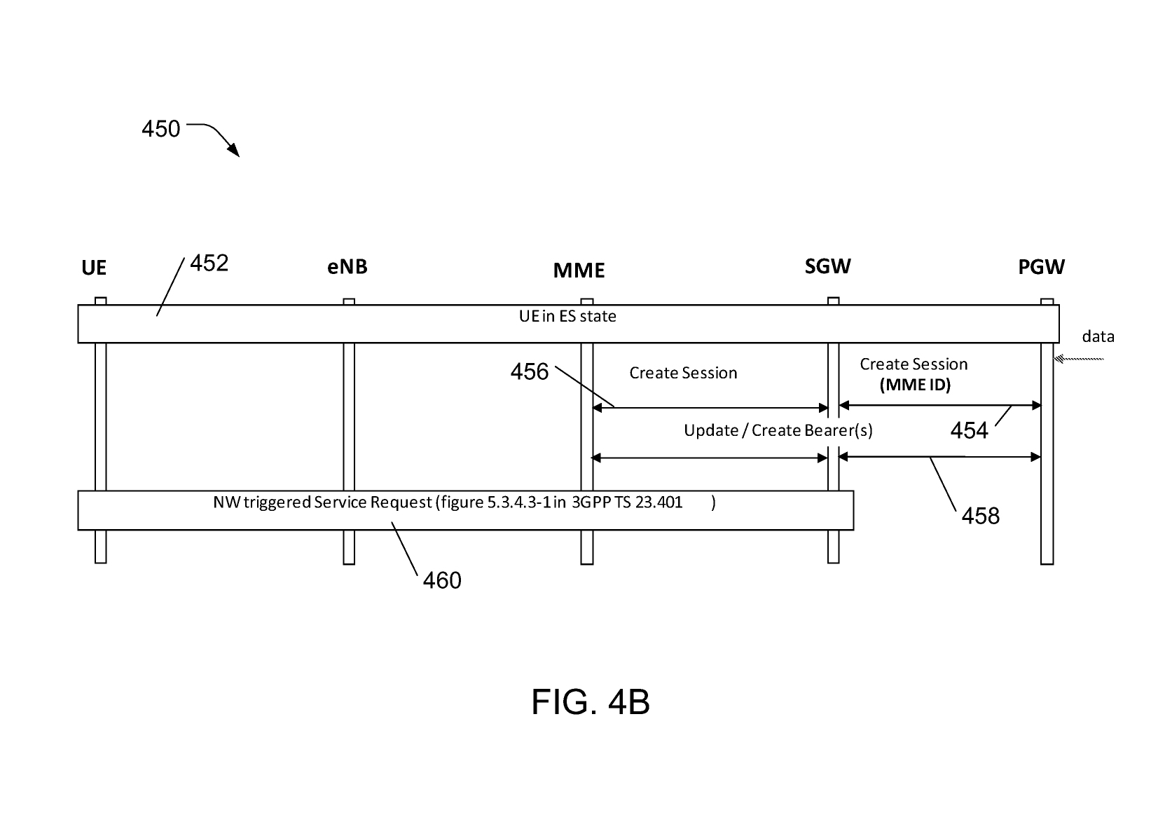

Naturally, the ES state as such appears explicitly in the UE 302. As shown in the deletions from the UE context data 312, the MME context data 314, the SGW context data 316 and PGW context data 318, bearer information in the UE 302, MME 304, SGW 306 and PGW(s) 308 is removed. Optionally (aiming at minimal MME storage), all context data for a UE on the MME 304, except IMSI and GUTI, may be compressed. Removing the bearers/connections (user and control planes) also reduces the necessary state to be maintained by each entity, and avoids regular processing of bearer/connection-related information (e.g. keep alive messages). Without bearers, the SGW 306 has no role to play, so all context data there (for this UE) can be removed, as shown in FIG. 3A. This facilitates switching-off of some SGWs. On UE wakeup, a signalling procedure for recreation of the (non-energy saving) idle state is used. From the UE side, the procedure is a mixture of tracking area update (TAU) and parts of attach (see FIG. 4a and the related description below). The determination of the assigned MME from the global unique temporary identifier (GUTI) works in the conventional manner and is done by the evolved node B (eNB) (based on MMECs). The procedure for terminating traffic (which also transitions the UE from the ES state, see FIG. 4b and description below) resembles a network-triggered packet data protocol (PDP) context activation without home subscriber server (HSS) lookup (because the MME ID is stored in the PGW(s)).

FIG. 3b shows a second variant or embodiment, in which context data 314 on MME 304 is removed and the key data for reachability (namely the tracking area index (TAI) list) is transferred to the SGW 306 or alternatively to another network entity (e.g. another MME (not shown) or a dedicated DB (not shown)). Also, some minimum data (a pointer to the compressed context data in the network) is transferred in a security protected format from the MME 304 to the UE 302. It should be noted that in some embodiments of this sort, all MMEs (in the pool of MMEs supporting this mechanism) should use the same hash or encryption method to enable this to work correctly.

As before, in this variant, the ES state appears explicitly in the UE 302. Additionally, a pointer to the compressed context data (effectively an ID that can be uniquely resolved to the network entity where the UE's context data are stored) is stored in the UE context data 312 as shown in FIG. 3b. This pointer may also be encrypted.

Bearer context data in UE 302, MME 304 and SGW 306 is removed (shown as crossed out in FIG. 3b), but is kept in the PGW(s) 308. This means that PGW functionality is unchanged. The SGW 306 (or alternatively another network element) also stores data items 320 for handling requests originated by the UE (temporary UE identity GUTI, in order to be able to associate it with the context data) and for terminating requests (TAI list assigned to UE, to be used in paging of the UE). No MME is assigned to the UE 302 when in ES state. Instead, the MME context data 314 is transferred in compressed form to the SGW 306, where it may be stored with the other data items 320. This facilitates switch-off of some MMEs (e.g. in conjunction with context offload schemes for MMEs).

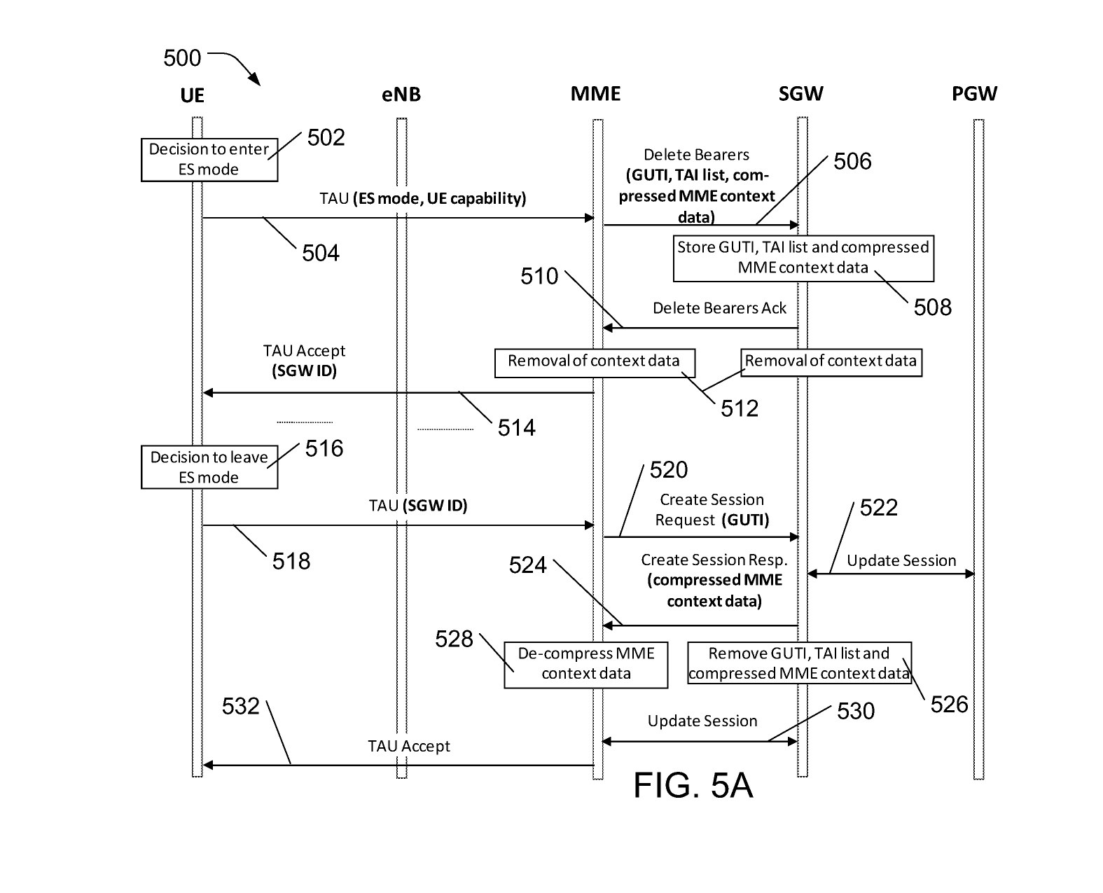

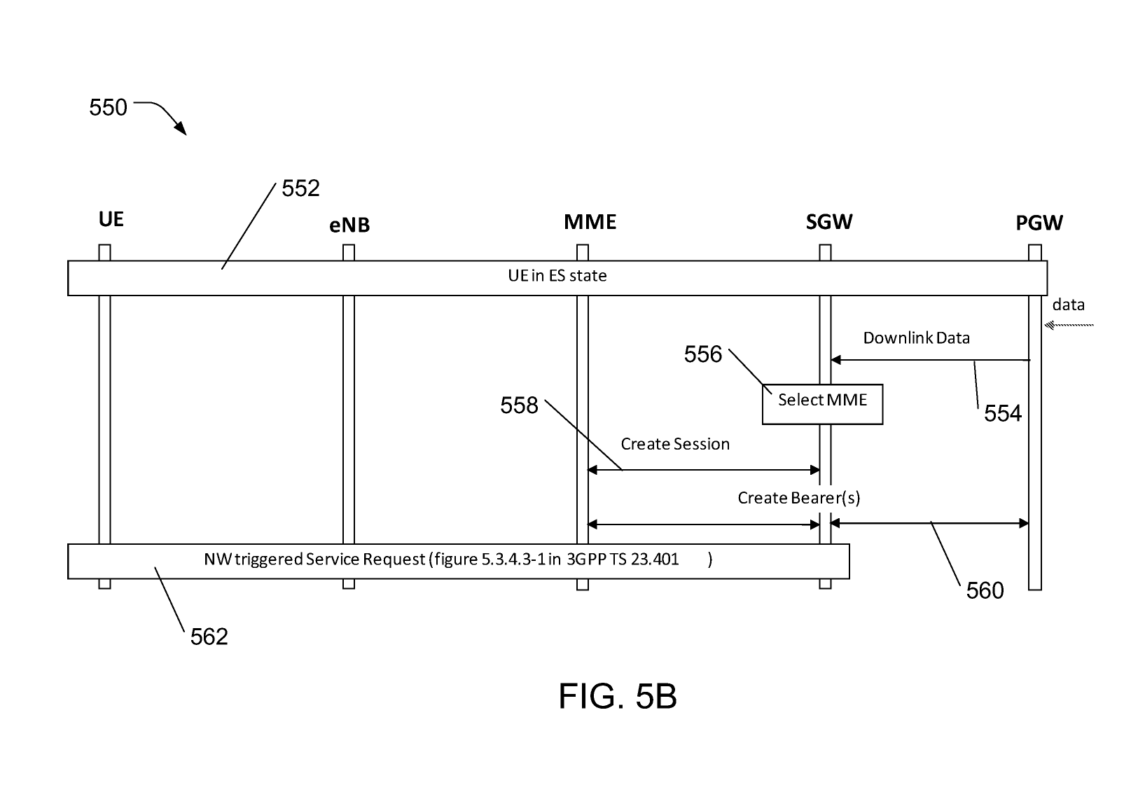

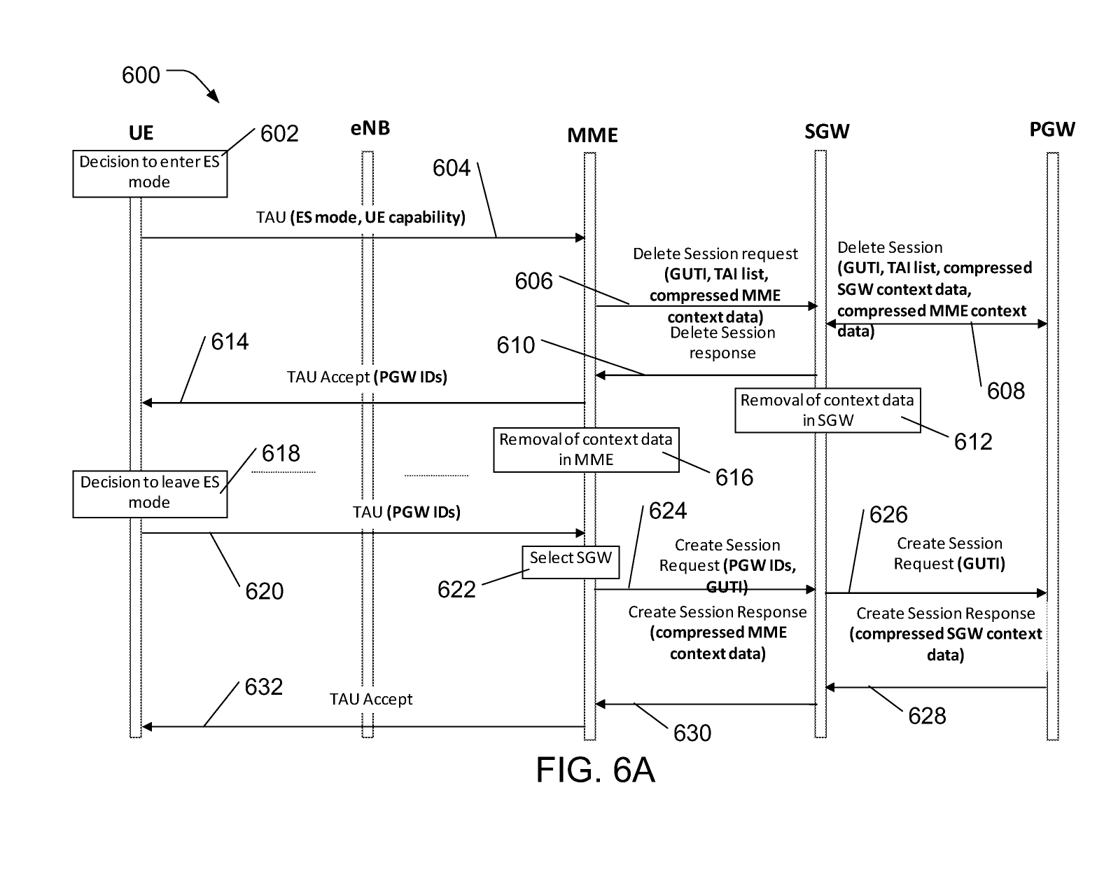

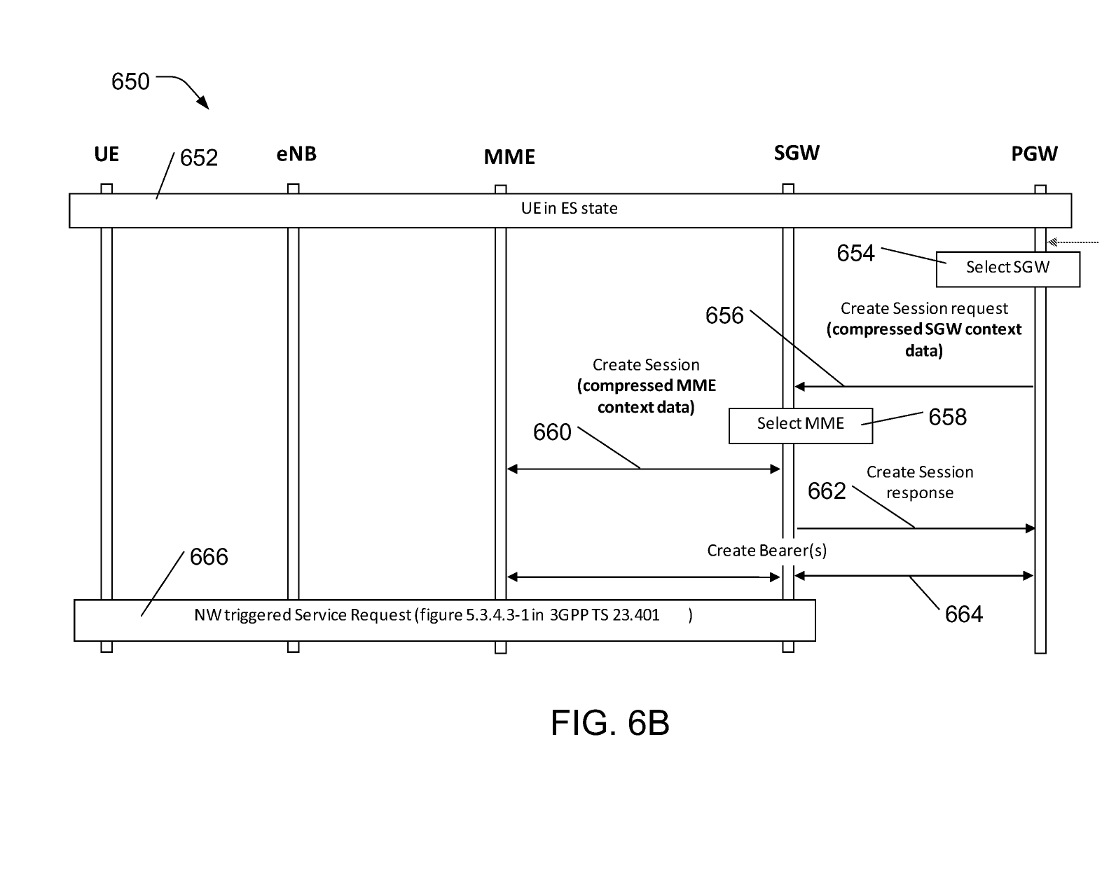

In the signalling procedure for recreation of the (non-energy saving) idle state, the UE originated procedure is again a mixture of TAU and parts of initial attach procedures (see FIG. 5a and accompanying description below). The determination of MME from GUTI works in a conventional manner from the eNB side (based on MMECs). The assumption is that even if there is no MME holding context for the UE, the MMEC contained in the GUTI must be handled somewhere, on one particular MME. This MME will be able to contact the appropriate SGW (based on the context pointer), from where UE's previous context in MME can be recreated and default bearers can be re-established. Similarly, terminating traffic arriving at the SGW triggers the recreation of context data in the network (see FIG. 5b and accompanying description below).

In a third variant or embodiment, as shown in FIG. 3c, as in the other embodiments, the ES state appears explicitly in the UE. Additionally, pointer(s) to the compressed context data (effectively the ID(s) of the PGW(s)) are stored with the UE context data 312, as shown in FIG. 3c. This pointer may also be encrypted. Bearer context data in UE 302, MME 304, SGW 306 and PGWs 308 is removed. PGW(s) 308 also store the data items 320 in their PGW context data 318, for handling requests originated by the UE 302 (temporary UE identity GUTI, in order to be able to associate it with the context data), as shown in FIG. 3c. The data for terminating requests (TAI list assigned to the UE, to be used in paging of the UE) is recreated from compressed data. Neither an MME nor a SGW is assigned to the UE 302 when in ES state; instead, the MME context data 314 is transferred in compressed form to the SGW 306, and from there it is transferred in compressed form to PGW(s) 308. This facilitates switch-off of some MMEs and SGWs (e.g. in conjunction with context offload schemes for MMEs and SGWs).

The signalling procedure for recreation of the (non-energy saving) idle state is described in detail below with reference to FIG. 6a. The main differences with respect to the variant described above with reference to FIG. 3b are that instead of SGW ID, the PGW ID(s) are used as the context pointer, and additionally an SGW should be selected.

It will be understood that additional embodiments may be created by employing a network node with a database independent from current evolved packet core (EPC) node functionality. In this case, more flexibility with respect to interfaces/protocols can be achieved. Further variants may result from a network-triggered change of UE state to ES. Protocol means are any network-triggered NAS message (e.g. service request, EMM information message, GUTI reallocation message etc.) or any response message of the network (e.g. TAU accept message, ATTACH accept message etc.).

It will further be understood that although these embodiments are described in terms of 3GPP technology, similar procedures can be designed for other technologies, such as WiMAX or CDMA2000 according to the description given here.

Referring now to FIG. 4a, a first embodiment of an information flow 400 for entering and leaving the ES state from the UE side (via TAU Requests) is described.

First, at 402, the user or a policy or application on the UE decides that it is time to enter ES mode. At 404, the UE sends a tracking area update (TAU) with an indication of ES mode to its current MME.

Next, at 406, the MME sends a Delete Bearer message to the UE's SGW, including its own ID. At 408, the SGW forwards the Delete Bearer message to the PGW, propagating the MME ID. The PGW acknowledges the request.

At 410, The SGW sends back the acknowledgement for the delete bearer message of step 406 to the MME. At 412, the SGW now can remove the context of this UE.

At 414, the MME sends back a TAU accept to the UE. From now on the UE is in ES mode. At 416, the MME can now delete or compress the UE's context data.

At 418, at some later stage, the UE decides to leave the ES state. To do this, at 420, the UE sends a normal TAU Request to the MME, i.e. without indication of ES state. At 422, the MME selects an SGW, according to the standard node selection procedure.

At 424, parts of the procedure in Initial Attach are executed between MME, SGW and PGW. This re-establishes the default bearer between SGW and PGW, as well as the related context data. Finally, at 426, the MME responds with TAU Accept to the TAU request of step 404.

FIG. 4b shows an information flow 450 for terminating traffic. This is conceptually similar to a network triggered PDP context activation (see 3GPP TS 23.060, “General Packet Radio Service (GPRS); Service description; Stage 2”), a difference being that MME address is found on PGW.

First, at 452, the UE is in an ES state (i.e., it has run the first part of the procedure described above with reference to FIG. 4a). Context data in the network has been removed.

At 454, terminating data for the UE arrives at one of the PGWs. The PGW initiates a message pair for session establishment with an SGW via S5/S8, including the MME ID. The PGW may store further incoming packets. It should be noted that for this reverse direction—as compared to “normal” 3GPP operation—the definition of Create Session request message may be enhanced.

At 456, the SGW initiates the exchange of a signalling message pair for session establishment with the MME. At 458, the PGW, SGW and MME continue signalling for the establishment of bearers. At 460, the network-triggered service request procedure is performed. This can be done partially in parallel with step 458.

Referring now to FIG. 5a, a further embodiment of an information flow 500 for entering and leaving the ES state from the UE side (via TAU Requests) is described.

At 502, the user or a policy or an application on the UE decides that it is time to enter ES mode.

At 504, the UE sends a TAU with indication of ES mode and UE's capability for this variant (i.e. storage of such a variant of a context pointer) to its current MME. To avoid an extra information element, the UE's capability may also be coded within the ES mode information element.

At 506, The MME sends a Delete Bearer message to the SGW, conveying GUTI, TAI list and compressed MME context data.

At 508, the SGW stores the received data, and at 510, the SGW acknowledges the received data.

At 512, the MME removes all its context data for this UE, and the SGW removes all context data except the newly (in step 508) stored data.

At 514, the MME sends a TAU accept message to the UE, including the SGW ID as a context pointer (in protected form). From now on the UE is in ES mode.

At 516, at some later stage the UE decides to leave the ES state. At 518, the UE sends a wake-up TAU Request to the MME which is currently handling the MMEC corresponding to the UE's GUTI. The SGW ID is included as the context pointer. It should be noted that the standard routing functionality on eNB guarantees the correct routing, even if MMECs have been reconfigured for the purpose of MME switch-off.

At 520, the MME decodes the SGW ID and initiates the creation of a session with that SGW for this UE. The GUTI is also included (in addition to IMSI).

At 522, based on the IMSI corresponding to the received GUTI, the SGW generates its part of the session state and updates the (still existing) session on the PGW.

At 524, the SGW acknowledges the creation of the session with the MME and includes the compressed MME context data in the Create Session response message. At 526, the SGW removes the data stored since step 508.

At 528, the MME decodes the compressed MME context data and links it with the session created in step 524. At 530, the MME exchanges update signalling for establishment of bearers with the SGW. Finally, at 532, the MME sends a TAU Accept message to the UE. From now on the UE is again in the “normal” (i.e. not in ES) state.

FIG. 5b shows an information flow 550 for terminating traffic. At the start, at 552, the UE is in an ES state (i.e., it has run the first part of the procedure described above with reference to FIG. 5a). Context data on the MME and partially on the SGW has been removed.

At 554, terminating data for the UE arrives at the SGWs.

At 556, the SGW selects an MME. The same functionality as in eNBs can be reused (based on MMECs corresponding to GUTI), or the MME could be found at random (within one pool, where the current pool of MMEs is found from TAI list). In the latter case a new GUTI should be assigned in the course of subsequent NAS signalling.

At 558, the SGW initiates the exchange of a signalling message pair for session establishment with the selected MME.

At 560, the PGW, SGW and MME continue signalling for the establishment of bearers.

Finally, at 562, the network-triggered service request procedure is performed. This can be done partially in parallel with step 560.

Referring now to FIG. 6a, a third embodiment of an information flow 600 for entering and leaving the ES state from the UE side (via TAU Requests) is described.

At 602, the user or a policy or an application on the UE decides that it is time to enter ES mode.

At 604, The UE sends a TAU with indication of ES mode and the UE's capability for this variant (i.e. storage of such a variant of a context pointer) to its current MME. It will be understood that to avoid an extra information element, the UE's capability may also be coded within the ES mode information element.

At 606, the MME sends a Delete Bearer message to the SGW, conveying GUTI, TAI list and compressed MME context data.

At 608, the SGW sends a Delete Session request message to the PGW(s), containing GUTI, TAI list and the compressed MME context data and its own compressed SGW context data (for PDN connections relevant to this PGW). Note that a rudimentary session concept is still in place, as the PGWs keep minimal (and compressed) context data.

At 610, the PGW(s) acknowledges the deletion of the session back to the SGW. At 612, the SGW can remove its context data.

At 614, the MME sends a TAU Accept message to the UE, including PGW ID(s) as context pointers in a protected form.

At 616, the MME can remove all context data for this UE. From now on the UE is in ES mode.

At 618, at some later stage the UE decides to leave the ES state.

At 620, the UE sends a wake-up TAU Request to the MME which is currently handling the MMEC corresponding to the UE's GUTI. The PGW ID(s) is included as the context pointer(s). It should be noted that the standard routing functionality on eNB guarantees the correct routing, even if MMECs have been reconfigured for the purpose of MME switch-off.

At 622, based on the received type of context pointer, the MME decodes the PGW IDs and determines that it should select an SGW. The standard conventional SGW node selection function can be used for this.

At 624, the MME sends a Create Session message to the SGW, conveying GUTI and PGW IDs.

At 626, per PGW, the Create Session request is propagated further, with the GUTI included.

At 628, based on the GUTI, the PGW is able to retrieve the stored, compressed context data. The PGW sends a Create Session response message back to the SGW, including compressed SGW context data.

Now the SGW decompresses the SGW context data. After responses from all involved PGWs have been received, the SGW at 630 sends a Create Session response message back to the MME, including the compressed MME context data.

Finally, at 632, the MME decompresses the context data and sends a TAU Accept message back to the UE. From now on the UE is again in “normal” (i.e. not in ES) state.

An information flow 650 for terminating traffic is shown in FIG. 6b.

At 652, the UE is in an ES state (i.e., it has run the first part of the procedure described above with reference to FIG. 6a). Context data in the MME and in the SGW has been removed.

At 654, terminating data for the UE arrives at (one of the) PGW(s). The PGW selects a SGW, based e.g. on the TAI list or MMEG part of the GUTI.

At 656, the PGW signals to the chosen SGW to establish a session for the UE, including the compressed SGW context data.

At 658, the SGW decompresses the received data, stores it locally and selects an MME (similar to the corresponding message flow for the embodiment described above with reference to FIG. 5b). The MME decompresses the received data and stores it locally.

At 660, the SGW signals to the chosen MME to establish a session for the UE, including the compressed MME context data.

At 662, the session establishment is acknowledged back from the SGW to the PGW.

At 664, the PGW, SGW and MME continue signalling for the establishment of bearers.

Finally, at 666, the network-triggered service request procedure is performed. This can be done partially in parallel with step 664.

As noted above, it is also possible to exit from an energy saving (ES) state with a UE initiated Service Request. A UE initiated direct transition from an ES state to an active state can be realized by assuming a service request message as a trigger (instead of a TAU request message), and applying the procedures similar to those described above with reference to FIGS. 4a, 5a, and 6a (i.e., steps 420 to 426 in FIG. 4a, steps 518 to 528 in FIG. 5a and steps 620 to 632 in FIG. 6a). When using the service request message instead of TAU request message for wake-up within overall procedures described with reference to FIGS. 5a and 6a, the service request message should be extended with information elements SGW ID and PGW ID(s), respectively.

In accordance with various embodiments of the invention, the introduction of a new energy saving state for UEs, which is exchanged between the UE and the network, allows the network to minimize the processing and context state for that UE. This permits the network to suspend bearer processing among mobile core network elements (e.g. MME, S-GW and P-GW). Further, this enables the network to compress UE context/bearer state in core network nodes, which allows the node to handle more UEs with the same memory and/or to save energy by hibernating parts of the memory. Additionally, network devices or nodes can store the compressed context/bearer state in non-volatile memory, allowing the node to handle more UEs with the same memory and/or save energy by hibernating parts of the memory. Embodiments of the invention may also enable the network to offload the compressed context/bearer state to another entity (e.g. another MME, a SGW, a PGW or any another DB), allowing hibernate/shutdown of network devices/nodes for the purpose of energy saving.

Further, in accordance with various embodiments of the invention, when the UE context/bearer state is compressed and stored in the mobile core network, a unique identifier/pointer for that UE state is created in order to allow fast resumption/re-establishment of the UE context/bearer state in the network. It should be noted that the UE state can be re-established on another network entity when the UE resumes its normal (idle or active) mode.

As described above, various embodiments of the invention also provide definition of a procedure for removing bearers for UEs in an ES state and re-establish them, definition of a procedure for compressing UE related context state information for UEs in an ES state in the network (e.g. in the MME), and definition of a procedure for “offloading” the (compressed) UE context state from the current MME to another network entity (e.g. another MME or P-GW).

Optionally, some embodiments may provide a dedicated control plane interface at the MME (e.g. from the PGW, but not limited to this case) to trigger a UE state change from an ES state to idle (or directly to active) mode.

Embodiments of the invention may also enable the PGW to maintain compressed PDN connection state for UEs in an ES state, allowing re-establishment of the PDN connection/bearer state in the SGW and/or MME upon terminating traffic towards the UE.

As described above, embodiments of the invention enable explicit handling of energy saving state in the UE and the NW, context data compression, enhancements in signaling procedures to support explicit ES states and context data compression, and enhancements in UE, MME, SGW and PGW functionality to support explicit ES states and context data compression, as well as the enhanced signaling procedures. These features enable savings in network node capacities/number of nodes, especially with the advent of machine type devices in mobile networks.

Thus, embodiments of the invention enable highly efficient energy saving in the EPC, due to cooperation with and awareness of UEs and potentially user. A high degree of removal or compression of context data is also enabled. Various embodiments also enable further utilization of energy saving states in the network (IMS, supplementary services, etc.). Advantageously, various embodiments of the invention are compatible with context data offload schemes, and can be applied to potentially all categories of UEs (e.g., machine-type-communication (MTC) like and mobile phones).

Although the various embodiments are discussed in the context of 3GPP technology, applications for other technologies, such as WiMAX and 3GPP2 are also envisioned.

While the invention has been shown and described with reference to specific embodiments, it should be understood that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A mobile communication system comprising a core network including one or more elements that handle bearer processing and/or that store user equipment context information for at least one user equipment or device that communicates through the core network, wherein elements of the core network are configured to suspend some or all bearer processing and/or to compress portions of or the whole user equipment context information for the at least one user equipment or device.

2. The mobile communication system of claim 1, wherein the elements of the core network are configured to transfer portions or all of the user equipment context information to other elements of the core network and/or to remove portions or all of the user equipment context information.

3. The mobile communication system of claim 1, wherein the elements of the core network are configured to suspend some or all bearer processing and/or to compress portions of or the whole user equipment context information for a user equipment or device in an energy saving state.

4. The mobile communication system of claim 3, further comprising a user equipment, wherein the user equipment is configured to operate in one of several states, including an explicit energy saving state, and wherein the user equipment is configured to inform the core network when the user equipment enters the explicit energy saving state.

5. The mobile communication system of claim 4, wherein the user equipment is further configured to inform the core network when the user equipment exits the explicit energy saving state.

6. The mobile communication system of claim 4, wherein elements of the core network are configured to suspend some or all bearer processing and/or to compress portions of or the whole user equipment context information for the user equipment when the user equipment enters the explicit energy saving state.

7. The mobile communication system of claim 4, wherein elements of the core network are configured to transfer portions or all of the user equipment context information to other elements of the core network and/or to remove portions or all of the user equipment context information when the user equipment enters the explicit energy saving state.

8. The mobile communication system of claim 6, wherein the mobile communication system is configured to create a unique identifier for the user equipment context information to provide for fast re-establishment of the user equipment context information in the core network when the user equipment exits the explicit energy saving state.

9. The mobile communication system of claim 8, wherein the user equipment context information can be re-established on a different entity of the core network when the user equipment exits the explicit energy saving state.

10. The mobile communication system of claim 1, wherein the mobile communication system comprises a 3GPP system.

11. The mobile communication system of claim 10, wherein the elements of the core network include a mobility management entity, and wherein a dedicated control plane interface is provided at the mobility management entity to trigger a user equipment state change from the explicit energy saving state to an idle state or an active state.

12. The mobile communication system of claim 10, wherein the elements of the core network include a mobility management entity (i.e. MME or SGSN), a serving gateway (i.e. S-GW or SGSN), and a packet data network gateway (i.e. PDN-GW or GGSN), and wherein the packet data network gateway maintains compressed packet data network context information for user equipment for re-establishment of the packet data network connection in the serving gateway and/or mobility management entity upon terminating traffic towards the user equipment.

13. The mobile communication system of claim 10, wherein the user equipment sends a tracking or routing area update request with an indication that it is entering the explicit energy saving state to its current mobility management entity in the core network when the user equipment enters the explicit energy saving state.

14. The mobile communication system of claim 4, wherein the mobile communication system comprises a 3GPP system, and wherein the user equipment sends a tracking or routing area update request to a mobility management entity in the core network when the user equipment exits the explicit energy saving state.

15. The mobile communication system of claim 14, wherein the tracking or routing area update request includes a serving gateway ID or a packet data network gateway ID as context pointers.

16. The mobile communication system of claim 1, wherein the elements of the core network store the compressed user equipment context information in non-volatile memory.

17. A method for saving energy in a mobile communication system including a core network, the method comprising:
suspending some or all bearer processing on a core network element and/or compressing portions of or the whole user equipment context information on the core network element for at least one user equipment or device that communicates through the core network.

18. The method of claim 17, further comprising transferring portions or all of the user equipment context information to other elements of the core network and/or removing portions or all of the user equipment context information.

19. The method of claim 17 further comprising:
providing an explicit energy saving state on a user equipment; and informing a core network when the user equipment enters the explicit energy saving state.

20. The method of claim 19, further comprising informing the core network when the user equipment exits the energy saving state.

21. The method of claim 19, further comprising suspending some or all bearer processing on a core network element and/or compressing portions of or the whole user equipment context information on the core network element when the user equipment enters the explicit energy saving state.

22. The method of claim 19, further comprising transferring portions or all of the user equipment context information to other elements of the core network and/or removing portions or all of the user equipment context information when the user equipment enters the explicit energy saving state.

23. The method of claim 21, further comprising creating a unique identifier for the user equipment context information to provide for fast re-establishment of the user equipment context information in the core network when the user equipment exits the explicit energy saving state.

24. A user equipment device for use in a mobile communication system including a core network, the user equipment device configured to operate in one of several states, including an explicit energy saving state, the user equipment device further configured to inform the core network when the user equipment device enters the explicit energy saving state.

25. The user equipment device of claim 24, wherein the user equipment device is a 3GPP device, and wherein the user equipment device is configured to send a tracking area update request with an indication that it is entering the explicit energy saving state to a current mobility management entity in the core network when the user equipment device enters the explicit energy saving state.
